(19) United States
(12) Patent Application Publication
(10) Pub. No.: US 2011/0298587 A1
(43) Pub. Date: Dec. 8, 2011

(54) SAFETY SYSTEM FOR AVOIDING WRONG USE OF MEDICINE

(75) Inventor: Michael Walz, Bingen (DE)

(73) Assignee: BOEHRINGER INGELHEIM INTERNATIONAL GMBH, Ingelheim am Rhein (DE)

(21) Appl. No.: 12/999,140

(22) PCT Filed: Jul. 3, 2009
(86) PCT No.: PCT/EP2009/058430

§ 371 Date: Jan. 24, 2011

(30) Foreign Application Priority Data
Jul. 3, 2008 (EP) 08159652.0

(51) Int. Cl. G06K 7/01

(52) U.S. Cl. 340/10.1

(57) ABSTRACT

A safety system (1) for avoiding wrong use of a medicine (2) with the aid of an applicator device (4) consisting of an RFID system of reader (5) and transponder (3) which are alternately assigned to the applicator device (4) and to the medicine (2). A use of the applicator device (4) or the removal of the medicine (2) from the package for use with the applicator device (4) is only possible when clearance is granted by the RFID system.

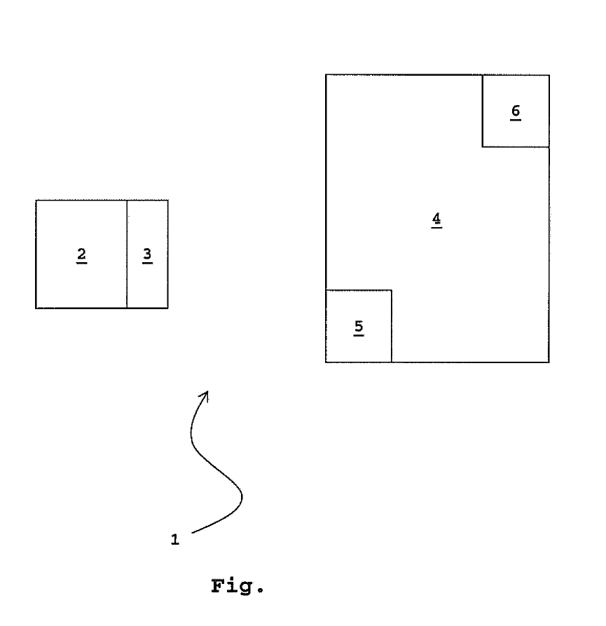

The invention relates to a safety system for avoiding the wrong use of a medicine which is administered by means of an applicator device.

Medicines are packaged in a variety of presentation forms to allow the patient to take a tablet or pill, for example, inject an active substance, inhale an aerosol or apply an active substance through the skin. Frequently, additional applicator devices are needed for taking and/or applying medicines, such as inhalers, syringes or other medical devices.

The correct association of a medicine that is to be administered with an applicator device by means of which the medicine is applied or taken is thus of considerable importance for preventing the administration of the wrong dosage of medicines, medicines or active substances or for preventing the use of the wrong medicine entirely.

For this it is known, inter alia, to design certain applicator devices, particularly inhalers, which cooperate with a cartridge, a bottle or other medicine container, such that for example only one specific type of package can be inserted and secured in a receiving opening. Thus, medicines made by another drug manufacturer cannot be used with an applicator device of this kind. Moreover, colour codes may be provided on medicine packaging and the associated applicator devices, warning notices may be contained on packages and in the information leaflets enclosed, or the use of particularly critical drugs may be reserved for trained medical staff only.

Starting from this prior art, the skilled man is confronted with the problem of providing a safety system of the kind mentioned above which effectively prevents the wrong use of a medicine by a simple method.

According to the invention, the problem is solved by assigning a transponder to the medicine and a reader of an RFID system to the applicator device, the use of the applicator device being enabled only when clearance is granted by the RFID.

Alternatively, the problem is solved by the fact that the transponder is assigned to the applicator device and the reader is mounted on the packaging unit, preferably the secondary packaging of the drug, to prevent the opening of the package and hence the use of the drug unless clearance has been granted by the RFID system.

RFID (in English: “radio frequency identification device”) systems usually comprise a transponder which is arranged on or in an object and a corresponding reader which is able to detect the presence of the transponder within a detection range by means of electromagnetic waves. The specific transponder is identified by means of an individual coding, so that it is possible to identify the individual transponder detected by the reader or the particular object to which the transponder is assigned.

An important parameter of RFID systems is the frequency range used. The ranges used are the low frequency range (LF, 30-500 kHz), the higher frequency range (HF, 3-30 MHz) or very high frequency range (UHF, 300 MHz-3 GHz) and the microwave frequency range (SHF, >3 GHz and above).

A typical radiofrequency for RFID systems according to the invention is 13.65 MHz. Systems of this kind are known in the art and are used for example for monitoring access by personnel, for supervising the flow of goods or as an anti-theft security system in large stores. LF systems often operate with frequencies of around 125 kHz and can cope with high (relative) humidity and metal and are used for example for access control, the blocking of travel routes and warehouse administration.

According to the invention, a transponder of this kind is now assigned to a medicine. The transponder may be associated for example with a primary package such as a blister pack, in which drug capsules are sealed by shrink-wrapping, or a secondary package, for example a cardboard box, in which one or more blister packs and information leaflets are inserted. For this purpose, the transponder may be secured inter alia by adhesion or lamination or by being shrink-wrapped on or in. The contactless read-out obtained with RFID systems enables the transponder to be mounted in a concealed location, thereby protecting it from damage. The associated reader is assigned to the applicator device and in the case of an inhaler, for example, it is integrated in the housing of the inhaler.

If a medicine is to be taken or applied by means of the applicator device, the packaging or the medicine with the associated transponder may be placed in the detection range of the reader on the applicator device. The reader automatically recognises that a permitted transponder which has the corresponding code for this medicine is located within the detection range. Then the reader is able to emit a clearance signal to free up the use of the device in cooperation with the medicine.

The advantage of the invention is that wrong use of medicines, medicines and the like is effectively prevented by a simple method using known means. Faulty use or misinterpretation is ruled out as the coding of the transponder is usually carried out at the factory. Obviously, the applicator device for administering medicines or the associated reader may also be designed so that different drugs with different transponder codes are able to cooperate with the applicator device, so that for example different aerosols, e.g. in different doses for children and adults, can be inhaled using the same inhaler.

The scope of the invention also includes an arrangement wherein the medicine that is to be administered is associated with a reader or detecting device of any desired construction to suit the skilled man and the applicator device by means of which the medicine is administered is associated with the transponder. Preferably, the reader is mounted on the packaging unit, preferably the secondary packaging, to prevent opening of the packaging and hence use of the medicine.

Preferably the applicator device or the packaging is secured as long as the reader does not receive a correct transponder signal in its detection range. Only when a permitted medicine or a permitted applicator device with the correct associated transponder is detected by the reader can a barrier, which may be mechanical, for example, be removed or an electronic device released to enable an aerosol cartridge or a capsule containing inhalable powder to be inserted in an inhaler, for example.

Theoretically it is also possible not to equip the applicator device itself or the packaging of the medicine with a reader but to place the applicator device or the packaging of the medicine in another container or a housing, the reader being assigned to this container/housing or a closure mechanism of the container/housing, and the release or opening only taking place when a permitted medicine or a permitted applicator device with the correct transponder code is present within the detection range.

For ease of operation, optical and/or acoustic warnings may be emitted when a correct or incorrect medicine is located within the detection range of the reader. If for example a drug made by the wrong manufacturer with an unreleased transponder is brought into the detection range of the reader, a red LED may light up and/or a warning tone may be sounded or a spoken message may be emitted to indicate that the medicine is not authorised. However, if the medicine is recognised as being correct, a green LED may light up and/or a corresponding positive spoken message may be emitted.

The remarks made in the previous paragraph concerning optical and/or acoustic warnings also apply analogously to cases where the transponder is assigned to the applicator device and the reader to the packaging, or where the reader and securing device are housed in an additional container or housing or are placed in the applicator device or the medicine.

It will be understood that the features mentioned above and explained in more detail hereinafter may be used not only in the particular combination stated but also in other combinations. The scope of the invention is defined only by the claims.

The invention will hereinafter be explained in more detail by means of an embodiment by way of example, with reference to the drawing. The single FIGURE shows a schematic representation of a safety system according to the invention.

The safety system 1 serves to prevent the wrong use or taking of a medicine 2. For this purpose the medicine 2, for example in a folded box containing a plurality of capsules in a blister pack, is associated with a transponder 3, preferably in the form of a corresponding magnetic strip which is adhesively attached to an inner surface of the folded box. A reader 5 is also assigned to an applicator device 4. The medicine 2 must cooperate with the applicator device 4 in order to be applied or taken, for example an aerosol cartridge or a capsule containing inhalable powder must cooperate with an inhaler or a liquid medicine supplied in dosed portions in a bottle must cooperate with an injection device.

The reader 5 is able to recognise whether the transponder 3 bears the correct code for the medicine 2, while the applicator device 4 may cooperate with various medicines 2 with different transponders 3. If the medicine 2 or the associated transponder 3 is evaluated as correct by the reader 5, the applicator device 4 is mechanically and/or electronically released to enable the medicine 2 to be taken or applied. At the same time a corresponding confirmation signal, or refusal signal in the event of the wrong medicine 2, can be emitted through an indicator device 6, for example a speaker and/or an LED.

### EXAMPLES

The following are examples of the construction of the safety system according to the invention for application systems from the field of pharmaceutical formulations for inhalation. The Examples also apply analogously to comparable application systems from other fields, e.g. injectable preparations, with medicines in single-dose containers or multi-dose containers, which are to be administered using a specific applicator device.

In Examples 1-5 the device for releasing or blocking the applicator device or for generating an optical and/or acoustic confirmation or refusal signal is connected to the reader of the RFID system in the applicator device, i.e. the inhaler in question. This device may be integrated in the inhaler itself or be produced in the form of an additional component, comparable with blinding devices or add-on devices for triggering by breathing.

1. Installation of Reader in Inhaler for Powder Capsules, e.g. Handihaler® (Boehringer Ingelheim) or Other Comparable Single Capsule Inhalers

| Alternative | |
|---|---|
| forms of | |
| assignment of | |
| the transponder | Remarks |
| Folded box | Transponder is mounted e.g. by sticking it to the inside |
| | of the box or by laminating it into the packaging |
| | material. |
| Blister strip | Transponder is mounted e.g. by sticking it to blisters or |
| | laminating it into the blister foil. |
| Pouch for | Transponder is mounted e.g. by sticking it to the pouch |
| blister strips | or laminating it into the pouch foil. |
| Single capsule | The individual transponders are mounted on the upper |
| | or lower part of the capsule e.g. by adhesion or by fusing |
| | them in the material of the capsule wall. |

### 2. Installation of Reader in Inhaler for Individual Blisters

| Alternative | |
|---|---|
| forms of | |
| assignment of | |
| the transponder | Remarks |
| Folded box | Transponder is mounted e.g. by sticking it to the inside |
| | of the box or by laminating it into the packaging |
| | material. |
| Pouch for | Transponder is mounted e.g. by sticking it to the pouch |
| individual blisters | or laminating it into the pouch foil. |
| or blister strips | |
| Individual blisters | The individual transponders are mounted on the lower |
| | part of the blister or cover film, e.g. by adhesion or by |
| | laminating them into the blister foil. |

### 3. Installation of Reader in Inhaler for Single Dose Containers

| Alternative | |
|---|---|
| forms of | |
| assignment of | |
| the transponder | Remarks |
| Folded box | Transponder is mounted e.g. by sticking it to the inside |
| | of the box or by laminating it into the packaging |
| | material. |
| Pouch for | Transponder is mounted e.g. by sticking it to the pouch |
| single dose | or laminating it into the pouch foil. |
| container | |
| Single dose | The individual transponders are mounted on the |
| container | container, e.g. by adhesion or by fusion in the container |
| | material; |
| | in the case of two-part containers: the individual |
| | transponders are mounted on the upper or lower part of |
| | the container, e.g. by adhesion or by fusion in the |
| | container material; |
| | in the case of sealed containers: the individual |
| | transponders are mounted on the lower part of the |
| | container or cover film e.g. by adhesion or by fusion or |
| | by laminating them into the cover foil. |

4. Installation of Reader in Multi-Dose Powder Inhalers with Replaceable Powder Reservoir

| Alternative | |
|---|---|
| forms of | |
| assignment of the | |
| transponder | Remarks |
| Folded box for | Transponder is mounted e.g. by sticking it to the inside |
| topping | of the box or by laminating it into the packaging |
| up/replacement | material. |
| reservoir | |
| Pouch for topping | Transponder is mounted e.g. by sticking it to the pouch |
| up/replacement | or laminating it into the pouch foil. |
| reservoir | |
| Topping up/ | Transponder is mounted on the powder reservoir, e.g. |
| replacement | by adhesion or by fusion in the reservoir material. |
| reservoir | |

5. Installation of Reader in Multi-Dose Liquid Inhaler with Replaceable Liquid Reservoir, e.g. Respimat (Boehringer Ingelheim) or Other Comparable Inhalers

| Alternative | |
|---|---|
| forms of | |
| assignment of the | |
| transponder | Remarks |
| Folded box for | Transponder is mounted e.g. by sticking it to the inside |
| topping | of the box or by laminating it into the packaging |
| up/replacement | material. |
| reservoir | |
| Pouch for topping | Transponder is mounted e.g. by sticking it to the pouch |
| up/replacement | or laminating it into the pouch foil. |
| reservoir | |
| Topping up/ | Transponder is mounted on the liquid reservoir, e.g. |
| replacement | by adhesion or by fusion in the reservoir material. |
| reservoir | |

In Example 6 the device for releasing or blocking the use or for generating an optical and/or acoustic confirmation or refusal signal is connected to the reader of the RFID system in the packaging. This device may be integrated in the packaging itself or be produced in the form of an additional component, e.g. in the form of a box or cage in which the packaging is inserted.

### 6. Installation of Reader in Packaging for Single Doses or Multi-Dose Containers

| Assignment | |
|---|---|
| of transponder | Remarks |
| Inhaler | Transponder is mounted e.g. by sticking it to the inside |
| | of the inhaler or by fusion in the inhaler material |

1. A safety system for preventing the wrong use of a medicine (2) which is administered using an applicator device (4), characterised in that a transponder (3) is assigned to the medicine (2) and a reader (5) of an RFID system is assigned to the applicator device (4), the use of the applicator device (4) being enabled only when a clearance has been granted by the RFID system.

2. A safety system for preventing the wrong use of a medicine (2) which is administered using an applicator device (4), characterised in that the transponder (3) is assigned to a primary packaging or a secondary packaging for the medicine (2) and a reader (5) of an RFID system is assigned to the applicator device (4), the use of the applicator device (4) being enabled only when a clearance has been granted by the RFID system.

3. A safety system for preventing the wrong use of a medicine (2) which is administered using an applicator device (4), characterised in that a reader (5) is assigned to the packaging of the medicine (2) and a transponder (3) of an RFID system is assigned to the applicator device (4), the removal of the medicine (2) from the packaging being enabled only when a clearance has been granted by the RFID system.

4. The safety system according to claim 1 or 2, characterised in that the reader (5) is integrated in the applicator device (4) that is constructed as an inhaler.

5. The safety system according to claim 1 or 2, characterised in that the applicator device (4) can be mechanically and/or electronically blocked in the event of the wrong transponder (3).

6. The safety system according to claim 3, characterised in that the packaging of the medicine (2) can be mechanically and/or electronically blocked in the event of the wrong transponder (3).

7. The safety system according to claim 1 or 2, characterised in that the mechanical and/or electronic blocking of the applicator device (4) is carried out by means of a container or housing having a closure mechanism to which the reader is assigned and in which the applicator device (4) is placed.

8. The safety system according to claim 3, characterised in that the mechanical and/or electronic blocking of the packaging for the medicine (2) is carried out by means of a container or housing with a closure mechanism to which the reader is assigned and in which the packaging of the medicine (2) is placed.

9. The safety system according to one of claims 1 to 3, characterised in that optical and/or acoustic warnings can be emitted by means of an indicator device (6) on the applicator device (4) or on the packaging of the medicine (2).
